(19) United States
(12) Patent Application Publication
(10) Pub. No.: US 2020/0012979 A1
(43) Pub. Date: Jan. 9, 2020

(54) SYSTEM AND METHOD FOR PROVIDING SERVICE OF LOADING AND STORING PASSENGER ARTICLE

(71) Applicant: LG Electronics Inc., Seoul (KR)

(72) Inventors: Kibong SONG, Seoul (KR); Hyunkyu KIM, Seoul (KR); Chul Hee LEE, Seoul (KR); Sangkyeong JEONG, Seoul (KR); Jun Young JUNG, Seoul (KR)

(21) Appl. No.: 16/557,212

(22) Filed: Aug. 30, 2019

(30) Foreign Application Priority Data
Jul. 9, 2019 (KR) 10-2019-0082897

(51) Int. Cl. G06Q 10/06; G05D 1/00; G05D 1/02; G06N 3/08; G08G 1/048

(52) U.S. Cl. CPC G06Q 10/06311; G05D 1/0088; G05D 1/0221; G05D 2201/0213; G08G 1/048; G05D 2201/0212; G06N 3/08

(57) ABSTRACT

A system for providing a service to load and store an article of a passenger of an autonomous vehicle may include one or more processors that are configured to: based on Deep Neural Networks (DNN) training using various information, determine a risk of damage corresponding to storage positions in a storage space of the autonomous vehicle that accounts for movement of loads in the storage space during travelling along the travel route; classify the storage space into at least one of a safety zone, a normal zone, or a danger zone according to the determined risk; and determine positions of a plurality of loads to be loaded based on the determined risk of each load, a weight of each load, and a size of each load.

### CROSS-REFERENCE TO RELATED APPLICATION

The present disclosure claims priority to and the benefit of Korean Patent Application No. 10-2009-0082897, filed on Jul. 9, 2019, the disclosure of which is incorporated herein by reference in its entirety.

### TECHNICAL FIELD

The present disclosure relates to a system and method for learning and analyzing a travel route and a state of luggage of a passenger using a sensor in an autonomous vehicle and artificial intelligence (AI) technology based on information on travelling, and providing an optimal service to load and store the luggage when a passenger gets on or off the autonomous vehicle.

### BACKGROUND

An autonomous vehicle may autonomously operate to a destination without an operation of a driver.

In some cases, the autonomous vehicle may include a space that may function as an independent space where a user may live and perform activities in addition to a space to transport the user.

For example, passengers may perform a variety of activities during movement of the autonomous vehicle, and various kinds of services may be provided to one of future industries for customers in which passengers may move freely in the vehicle.

A vehicle may include a space (e.g., trunk) to load objects having various shapes and sizes.

For instance, the vehicle may include a trunk room, which is a space to load various kinds of luggage which may be too bulky to be loaded in the vehicle. In particular, the trunk room may have a wider space to load a large amount of luggage of many customers. For example, an express bus may transport many passengers and include a trunk room to load luggage of the passengers.

In some cases, the luggage in the trunk room may generate noise due to breakage of articles or collision between the articles that may move in the trunk during travelling of the vehicle.

In some cases, no additional equipment is provided to fix various kinds of loads to be loaded in the trunk room. In such cases, fragile objects or objects having a high degree of risk may be damaged when there is a curved road or a road with a high degree of slope along which the vehicle travels. In addition, when the vehicle travels with the load in the trunk room of the vehicle, the noise may be generated due to abnormality thereof, and the loads may be broken.

In some cases, passengers of a passenger transportation vehicle may load luggage into the trunk room in an order in which passengers boarded at designated places, and may find the load stored in the trunk room when the passengers get off the passenger transportation vehicle.

### SUMMARY

The present disclosure provides a system and a method for learning and analyzing a travel route and a state of the load of the passenger using a sensor in the autonomous vehicle and AI technology based on the information on travelling, and providing an optimal service to load and store the luggage when the passenger gets on or off the autonomous vehicle.

The present disclosure also provides a system and a method for providing a service to load and store the article of the passenger, which may multiply marketability of vehicles by determining a state of various kinds of loads loaded in the trunk room and stably transporting the loaded loads while preventing or reducing noise from occurring due to a risk of the load and a movement of the load during travelling along the travel route.

The objects of the present disclosure are not limited to the above-mentioned objects, and other objects and advantages of the present disclosure which are not mentioned may be understood by the following description and more clearly understood by the implementations of the present disclosure. It will also be readily apparent that the objects and the advantages of the present disclosure may be implemented by features defined in claims and a combination thereof.

According to one aspect of the subject matter described in this application, a system for providing a service to load and store an article of a passenger of an autonomous vehicle includes: an information collector configured to collect at least one of travel information of the autonomous vehicle, weather information, or traffic information, the travel information including information on a travel route from a current position to a destination of the autonomous vehicle; and an event section analyzer configured to analyze at least one of the travel information, the weather information, or the traffic information with dynamic information, the dynamic information including at least one of (i) information on a plurality of sections of the travel route including a curved section, a sliding section, or a slope section, (ii) a predicted speed of the autonomous vehicle corresponding to each section of the travel route, or (iii) an occurrence of a dangerous situation in the travel route.

The system further includes a training processor configured to: based on Deep Neural Networks (DNN) training using the dynamic information analyzed by the event section analyzer, determine a risk of damage corresponding to storage positions in a storage space of the autonomous vehicle that accounts for movement of loads in the storage space during travelling along the travel route, and classify the storage space into at least one of a safety zone, a normal zone, or a danger zone according to the determined risk; and a zone classifying unit configured to determine positions of a plurality of loads to be loaded among at least one of the safety zone, the normal zone, or the danger zone based on the determined risk of each load, a weight of each load, and a size of each load.

Implementations according to this aspect may include one or more of the following features. For example, the system may further include a monitoring processor configured to provide an image of luggage of the passenger to a user terminal of the passenger or to a display installed at the autonomous vehicle. In some examples, the monitoring processor may be configured to: display, on the user terminal or the display, a position of the luggage at which the luggage is unloaded based on the passenger getting off the autonomous vehicle, or notify the passenger of the position through a voice.

In some implementations, the information collector may be configured to: collect the travel information, the travel information including at least one of the curve section, the slope section, the sliding section, or a state of a road surface in the travel route to the destination of the autonomous vehicle; collect the weather information; and collect the traffic information, the traffic information including at least one of a road situation or a traffic situation in the travel route. In some examples, the weather information may include (i) weather information on a place where the autonomous vehicle is located, (ii) weather information for a period of time while the autonomous vehicle travels to the destination of the autonomous vehicle, and (iii) weather information corresponding to each section of the travel route of the autonomous vehicle.

In some implementations, the event section analyzer may be configured to: analyze an unevenness and a smoothness of a road surface corresponding to each section of the travel route, where the unevenness represents a topography of each section of the travel route, and the smoothness represents a slipperiness of each section of the travel route; analyze a curve and a slope in the travel route; analyze traffic corresponding to each section of the travel route based on the traffic information, the traffic information including at least one of a road situation or a traffic situation predicted to occur while the autonomous vehicle travels along the travel route; and determine a risk section including at least one of a slippery region, a bump region, a landslide region, or a frequent accident region in the travel route.

In some implementations, the safety zone may be positioned in the normal zone or at a predetermined height vertically above the normal zone.

According to another aspect, a method for providing a service to load and store an article of a passenger of an autonomous vehicle includes: collecting at least one of travel information on a travel route of the autonomous vehicle to a destination, weather information, or traffic information; analyzing at least one of the travel information, the weather information, or the traffic information with dynamic information, the dynamic information including at least one of (i) information on a plurality of sections of the travel route including a curved section, a sliding section, or a slope section, (ii) a predicted speed of the autonomous vehicle corresponding to each section of the travel route, or (iii) an occurrence of a dangerous situation in the travel route; determining, based on DNN training using the dynamic information, a risk of damage corresponding to storage positions in a storage space of the autonomous vehicle that accounts for movement of loads in the storage space during travelling along the travel route; classifying the storage space into at least one of a safety zone, a normal zone, or a danger zone according to the determined risk; and determining positions of a plurality of loads to be loaded among at least one of the safety zone, the normal zone, or the danger zone based on the determined risk of each load, a weight of each load, and a size of each load.

Implementations according to this aspect may include one or more of the following features. For example, collecting at least one of the travel information, the weather information, and the traffic information may include: collecting information on the plurality of sections and a state of a road surface in the travel route; collecting at least one of (i) weather information on a place where the autonomous vehicle is located, (ii) weather information for a period of time while the autonomous vehicle travels to the destination of the autonomous vehicle, and (iii) weather information corresponding to each section of the travel route of the autonomous vehicle; and collecting the traffic information, the traffic information including at least one of a road situation or a traffic situation in the travel route.

In some examples, collecting the travel information may include: based on the travel information being previously stored in a database, obtaining information stored in the database corresponding to the travel route; and based on travel information not being previously stored in the database, obtaining information on the travel route that is detected by another vehicle or the autonomous vehicle travelling the travel route.

In some implementations, analyzing the dynamic information may include: analyzing an unevenness an a smoothness in a road surface of each section in the travel route, where the unevenness represents a topography of each section of the travel route, and the smoothness represents a slipperiness of each section of the travel route; analyzing a curve and a slope in the travel route; analyzing a traffic for each section of the travel route based on the traffic information, the traffic information including at least one of a road situation or a traffic situation in the travel route; and determining a risk section including at least one of a slippery region, a bump region, a landslide region, or a frequent accident region in the travel route.

In some implementations, the method may further include providing an image of luggage of the passenger to a user terminal of the passenger or to a display installed in the autonomous vehicle. In some examples, providing the image of the luggage may include: based on the passenger getting on the autonomous vehicle, acquiring a first image of at least one of the passenger and the luggage of the passenger by a camera installed at the autonomous vehicle; recognizing the passenger or the luggage of the passenger based on the first image; based on recognizing the passenger, determining whether the recognized passenger corresponds to a registered passenger previously stored in a passenger list; based on the recognized passenger corresponding to an unregistered passenger in the passenger list, generating information including an identification of the unregistered passenger, and registering the unregistered passenger in the passenger list as a registered passenger; based on the recognized passenger corresponding to the registered passenger previously stored in the passenger list, acquiring information corresponding to the registered passenger through a server, the information corresponding to the registered passenger including an identification of the registered passenger; based on recognizing the luggage, generating a luggage identification (ID) corresponding to the recognized luggage; generating mapping information based on mapping the luggage ID to the identification of the corresponding passenger; and based on the mapping information, providing, to the display or the user terminal, the image of the luggage that is loaded at a position in the storage space.

In some implementations, recognizing the passenger or the luggage of the passenger may be performed through an object detection of a face of the passenger and a shape of the luggage using the DNN.

In some implementations, the method may further include: based on the passenger getting off the autonomous vehicle, displaying, on the user terminal or the display, a position at which the luggage is unloaded; or notifying the passenger of the position through a voice. In some examples, displaying the position of the luggage or notifying the passenger of the position of the luggage may include: obtaining information on a first destination of a first passenger in the autonomous vehicle; based on the autonomous vehicle arriving at the first destination, determining whether first luggage of the first passenger is registered in mapping information including a passenger ID and a luggage ID that are mapped to each other; based on a determination that the first luggage is registered in the mapping information, identifying the first luggage in the storage space based on the luggage ID corresponding to the first luggage; based on identifying the first luggage present in the storage space, unloading the first luggage at the first destination.

In some implementations, displaying the position of the luggage or notifying the passenger of the position of the luggage further may include outputting a loss notification based on determining an absence of the first luggage in the storage space.

In some implementations, the method may further include: based on an unload position at which the first luggage is unloaded being different from a position of the first passenger at which the first passenger gets off the autonomous vehicle, displaying the unload position to a first display installed inside of the autonomous vehicle and a second display installed outside of the autonomous vehicle.

In some implementations, the method may further include, based on a unload position at which the first luggage is unloaded being different from a position of the first passenger at which the first passenger gets off the autonomous vehicle, displaying the unload position to a user terminal of the first passenger. In some implementations, the method may further include: based on an unload position at which the first luggage is unloaded being different from a position of the first passenger at which the first passenger gets off the autonomous vehicle, providing the first passenger with a guide to the unload position.

In some implementations, the system and method for providing the service to load and store the article of the passenger may include a configuration of accurately mapping the passenger to the luggage using the AI technology.

In some implementations, the system and the method for providing the service to load and store the article of the passenger may include a configuration of determining a travel route of the autonomous vehicle using the AI technology.

In some implementations, the system and the method for providing the service to load and store the article of the passenger may include a configuration of determining a risk (an importance) of the luggage of the passenger.

In some implementations, a display may be provided to monitor the stored luggage, by the passenger, using augmented reality (AR), in the system and the method for providing the service to load and store the article of the passenger.

In some implementations, the system and method for providing the service to load and store the article of the passenger may include a configuration of providing a service to unload the luggage when the passenger gets off the autonomous vehicle and notify the passenger of the position at which the luggage is unloaded.

A specific effect of the present disclosure, in addition to the above-mentioned effect, will be described together while describing a specific matter to implement the present disclosure.

### BRIEF DESCRIPTION OF THE DRAWINGS

FIG. 1 shows an example system including an example of an autonomous vehicle.

FIG. 2 is a block diagram showing an example configuration of a system of providing a service to load and store an article of a passenger in an autonomous vehicle.

FIG. 3 is a detailed block diagram showing an example configuration of an event section analyzer in FIG. 2.

FIG. 4 shows an example of a safety zone and a normal zone in a trunk room determined by a deep neural network (DNN) training processor in FIG. 2.

FIG. 5 shows an example space in a trunk room classified by a zone classifying unit in

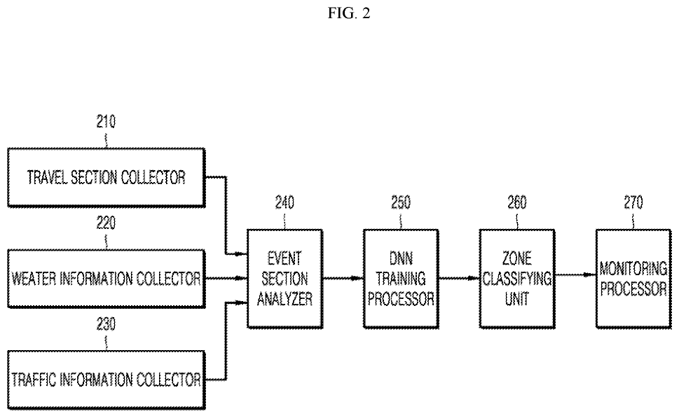

FIG. 2.

FIG. 6 shows an example items classified by characteristics corresponding to various kinds of luggage in Table 1.

FIG. 7 is a flowchart of an example method for providing a service to load and store an article of a passenger.

FIG. 8 is a flowchart of an example method for monitoring luggage by a monitoring processor.

FIGS. 9A and 9B show examples in which monitoring processors obtain images of passengers and luggage of the passengers.

FIG. 10 is a flowchart of an example monitoring method performed by a monitoring processor to notify a passenger of unloading of luggage when the passenger gets off an autonomous vehicle.

### DETAILED DESCRIPTION

The above-mentioned objects, features, and advantages of the present disclosure will be described in detail with reference to the accompanying drawings. Accordingly, the skilled person in the art to which the present disclosure pertains may easily implement the technical idea of the present disclosure. In the description of the present disclosure, when it is determined that a detailed description of a well-known technology related to the present disclosure may unnecessarily obscure the gist of the present disclosure, details thereof are omitted. One or more implementations of the present disclosure are described in detail with reference to the accompanying drawings. In the drawings, same reference numerals are used to refer to same or similar components.

When a component is described as being “connected,” “coupled,” or “connected” to another component, the component may be directly connected or able to be connected to the other component; however, it is also to be understood that an additional component may be “interposed” between the two components, or the two components may be “connected,” “coupled” or “connected” through an additional component.

A system and a method for providing a service to load and store an article of a passenger according to one or more implementations of the present disclosure will be described below.

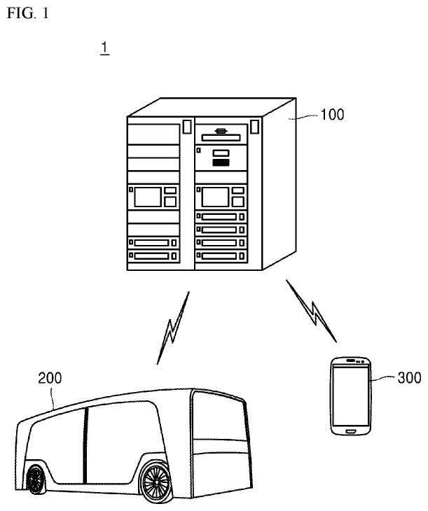

FIG. 1 shows an example system including an example of an autonomous vehicle.

As shown in FIG. 1, a system 1 of an autonomous vehicle may include a server 100, an autonomous vehicle 200, and a user terminal 300. The above configuration corresponds to an example implementation, and the components thereof are not limited to the implementation shown in FIG. 1. In some examples, some components thereof may be added, changed, or omitted as necessary.

In some implementations, the server 100, the autonomous vehicle 200, and the user terminal 300 included in the overall system 1 may be connected to one another through a wireless network, to perform mutual data communication.

In some implementations, the user terminal 300 may be defined as a terminal of a user who is provided with customized recommendation service. That is, the user terminal 300 may be provided as one of various types of components, for example, electronic apparatus such as a computer, a Ultra Mobile PC (UMPC), a workstation, a net-book, a Personal Digital Assistants (PDA), a portable computer, a web tablet, a wireless phone, a mobile phone, a smart phone, an e-book, a portable multimedia player (PMP), a portable game machine, a navigation apparatus, a black box or a digital camera, which are related to the autonomous vehicle 200 and are carried by user. However, the present disclosure is not limited thereto.

In order for the user terminal 300 to receive the service with respect to the autonomous vehicle, an application for service may be installed in the user terminal 300. The user terminal 300 may be driven by the operation of the user and the user executes the installed application through a simple method in which the user selects (e.g., touches or presses buttons of) the application for service displayed on a display window (i.e., a screen) of the user terminal 300 to access the server 100.

In some implementations, information on the position itself provided by a GPS satellite and geographical information to be displayed on the map, for example, geographical information provided by the GIS may be stored in and managed by the user terminal 300. That is, the user terminal 300 may display information on the position itself and the position of the autonomous vehicle 200 in real time through a method in which the user terminal 300 receives the information on the position of the autonomous vehicle 200 (for example, position coordinates) in a data form to displays the data on the map stored in the terminal.

The server 100 transmits the route of the autonomous vehicle to the autonomous vehicle and controls the autonomous control, according to the situation of the user and the situation of the autonomous control. The server 100 may identify the current position of the autonomous vehicle 200 based on the GPS signal received from the GPS module of the autonomous vehicle 200. Further, the server 100 may refer to database or access a traffic information server to identify the arrival position based on the information on the arrival position. Based on the above, the server 100 may generate the route of the autonomous vehicle, along which the autonomous vehicle is travelled from the current position to the arrival place of the autonomous vehicle 200 in response to the situation of the autonomous control. In some implementations, the situation of the autonomous control may include dynamic information including a road situation, a traffic situation, a possible arrival time, a speed of the autonomous vehicle, from a position of a user to the arrival place.

In some implementations, the server 100 may include hardware having a similar configuration as a general web-server and software including a program module that is implemented through various types of computer programming languages, for example, C, C++, Java, Visual Basic, Visual C, and the like and performs various types of functions. The server 100 may be constructed based on cloud and may store and manage information collected by the autonomous vehicle 200 and the user terminal 300 connected to each other through the wireless network. The server 100 may be operated by a transportation enterprise server such as a car-sharing company and may control the autonomous vehicle 200 using wireless data communication.

The server 100 may identify the current position of the autonomous vehicle 200 through the GPS signal received from the GPS module of the autonomous vehicle 200. The server 100 may transmit, to the transportation enterprise server, the information on the identified current position of the autonomous vehicle 200 as a departure and may transmit, to the transportation enterprise server, the information on the arrival position corresponding to information on the arrival position as a destination and may call for the transportation enterprise vehicle.

The transportation enterprise server may search for a transportation enterprise vehicle that may be moved from the current position to the arrival position, of the autonomous vehicle 200, and may drive the vehicle to the current position of the autonomous vehicle 200. For example, when the taxi managed by the transportation enterprise server is a manned taxi, the transportation enterprise server may provide the driver of the taxi with information on the current position of the autonomous vehicle 200. In some examples, where the taxi managed by the transportation enterprise server is an unmanned taxi, the transportation enterprise server may generate a route of the autonomous vehicle from the current position of the taxi to the current position of the autonomous vehicle 200 and may control for the taxi to operate along the route of the autonomous vehicle.

In some implementations, the autonomous vehicle 200 may travel to a destination by itself without the operation of the operator according to the situation of the user and the autonomous of the autonomous control during autonomous control of the vehicle through the monitoring system in the vehicle. The autonomous vehicle 200 may have a concept including any moving apparatus such as automobiles and motorcycles; however, it is described that the autonomous vehicle 200 is an automobile for convenience of explanation.

FIG. 2 is a block diagram showing an example configuration of a system for providing a service to load and store an article of a passenger, in an autonomous vehicle. The system for providing the service to load and store the article of the passenger shown in FIG. 2 corresponds to an implementation, and components thereof are not limited to the implementation shown in FIG. 2, and some components thereof may be added, changed, or deleted as necessary.

As shown in FIG. 2, the system for providing the service to load and store the article of the passenger in the autonomous vehicle according to the present disclosure includes a travel section collector 210, weather information collector 220, traffic information collector 230, event section analyzer 240, Deep Neural Networks (DNN) training processor 250, and a zone classifying unit 260. In some implementations, the travel section collector 210, the weather information collector 220, the traffic information collector 230, the event section analyzer 240, the DNN training processor 250, and the zone classifying unit 260 may be implemented by one or more processors such as a controller, a microprocessor, an integrated circuit, etc. In some implementations, the travel section collector 210, the weather information collector 220, the traffic information collector 230, the event section analyzer 240, the DNN training processor 250, and the zone classifying unit 260 may be implemented by one or more of software components (e.g., instructions) stored in a non-transitory memory connected to one or more processors.

The travel section collector 210 collects information on the travel section such as a curve, a slope road, a slide section, a state of a road surface in the moving route to the destination of the autonomous vehicle. In some examples, the information on the travel section may be collected based on the previously stored information such as the curve, the slope road, and a slipperiness caution section. However, the present disclosure is not limited thereto, and it may be possible to collect the information based on information detected by another vehicle or his or her own vehicle during traveling. When the information detected by another vehicle or his or her own vehicle during travelling is collected, information on the slippery section or information on the state of the road surface may be more accurately collected.

The weather information collector 220 collects weather information from the server 100 or a server of providing weather information (e.g., Meteorological Administration). For example, the weather information collector 220 may collect current weather information on a zone where the autonomous vehicle 200 is located, weather information for a period of time until the autonomous vehicle 200 is arrived at the destination of the autonomous vehicle, and weather information for each zone (for each position) in the moving route of the autonomous vehicle 200.

The traffic information collector 230 may collect traffic information such as a road situation and a traffic situation from the server 100 or a server of providing traffic information (e.g., Road Traffic Authority). In some implementations, the traffic information for each zone (for each position) in the moving route of the autonomous vehicle 200 may be collected. The event section analyzer 240 analyzes the information on the travel section, the weather information, and the traffic information collected by the travel section collector 210, the weather information collector 220, and the traffic information collector 230 and analyzes the dynamic information including a curved section, a slippery section, a slope section provided during travelling from the current position to an arrival place of the autonomous vehicle 200, a predicted speed for each section during travelling from the current position to an arrival place of the autonomous vehicle 200, and a dangerous situation occurring during travelling from the current position to an arrival place of the autonomous vehicle 200.

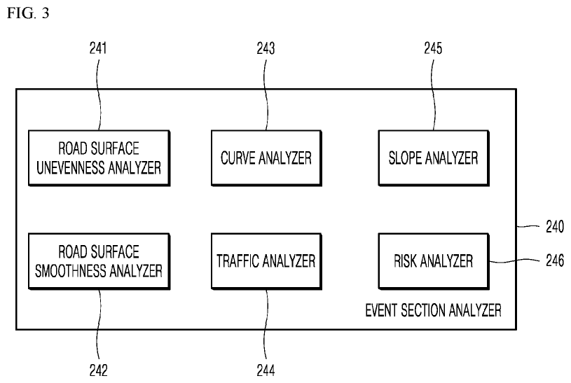

FIG. 3 is a detailed block diagram of an example configuration of the event section analyzer in FIG. 2.

As shown in FIG. 3, an event section analyzer 240 includes a road surface unevenness analyzer 241, a road surface smoothness analyzer 242, a curve analyzer 243, a traffic analyzer 244, a slope analyzer 245, and a risk analyzer 246. As described above, some or all of these analyzers may be implemented by one or more hardware processors or by one or more software components.

The road surface unevenness analyzer 241 analyzes the unevenness of the road surface for each section of the travel route from the current position to the arrival place of the autonomous vehicle 200. In some implementations, the unevenness of the road surface may be analyzed based on information on the section of the road surface having unevenness of the road surface collected by the travel section collector 210, but is not limited thereto. That is, when the information on the state of the road surface detected by another vehicle or his or her own vehicle during travelling is collected, it is possible to analyze the unevenness of the road surface based on the collected information on the state of the road surface. In some examples, the unevenness may represent a topography of the travel route such as bump regions or recess regions in each section of the travel route.

The road surface smoothness analyzer 242 analyzes the smoothness of the road surface for each section of the travel route from the current position to the arrival place of the autonomous vehicle 200. In some implementations, the smoothness of the road surface may analyzed based on the information on the section of the road surface having the smoothness of the road surface collected by the travel section collector 210, but is not limited thereto. That is, when the information on the road surface detected by another vehicle or his or her own vehicle is collected, the smoothness of the road surface may be analyzed based on the collected information on the road surface, and the like. In some examples, the smoothness may represent a slipperiness of each section of the travel route.

In some implementations, the unevenness and smoothness may be determined independently. In some implementations, one of the unevenness of smoothness may be determined, and the other of the unevenness or smoothness may be determined based on relation between the unevenness and smoothness. For example, as the unevenness increases, the smoothness may decrease.

The curve analyzer 243 analyzes the route of the curve in the travel route from the current position to the arrival place of the autonomous vehicle 200. In some implementations, the route of the curve may be analyzed using the travel route collected by the travel section collector 210, but is not limited thereto. That is, when the information on the curve detected by another vehicle or his or her own vehicle during travelling is collected, it is possible to analyze the curve section based on the collected information on the curve.

The traffic analyzer 244 analyzes the traffic for each section based on traffic information such as a road situation, a traffic situation, and the like, which occur in the travel route from the current position to the destination of the autonomous vehicle 200. In some implementations, the traffic for each section may be analyzed based on the traffic information collected by the traffic information collector 230, but the present disclosure is not limited thereto. That is, when the traffic information detected by another vehicle or his or her own vehicle during travelling is collected, the traffic for each section may be analyzed based on the collected traffic information.

The slope analyzer 245 analyzes the slope in the travel route from the current position to the arrival place of the autonomous vehicle 200. In some implementations, the analysis of the slope may be performed by analyzing the slope section in the travel route collected by the traveling section collector 210, but is not limited thereto. That is, when the information on the slope detected by another vehicle or his or her own vehicle during travelling is collected, the slope section may be analyzed based on the collected information on the slope, and the like.

The risk analyzer 246 analyzes the risk in the travel route from the current position to the arrival place of the autonomous vehicle 200. In some implementations, the risk analysis may be performed by analyzing the risk section such as slipperiness, a bump in the travel route collected by the travel section collector 210, and a landslide, frequent accidents occurring in the travel route collected by the travel section collector 210.

Next, the DNN training processor 250 performs training based on Deep Neural Networks (DNN), using the dynamic information analyzed by the event section analyzer 240 and infer a risk for each position of the load loaded in the trunk room during travelling of the autonomous vehicle 200 and a direction of movement of the load during travelling along the travel route. In some implementations, the DNN training processor 250 may use the learning data indicating stability according to a position of the trunk room, in addition to the analyzed dynamic information.

The DNN training processor 250 classifies the trunk room into at least one of a safety zone, a normal zone, and a danger zone according to the inferred risk for each section of the load and the direction of movement of the load during traveling along the travel route. However, in some implementations, the classified zones are not limited thereto. For ease of explanation, the zones are classified into the safety zone and the normal zone.

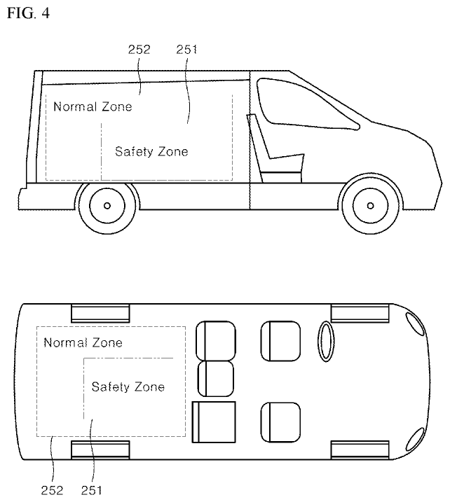

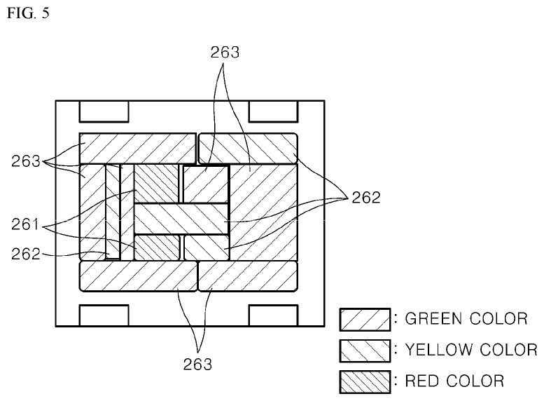

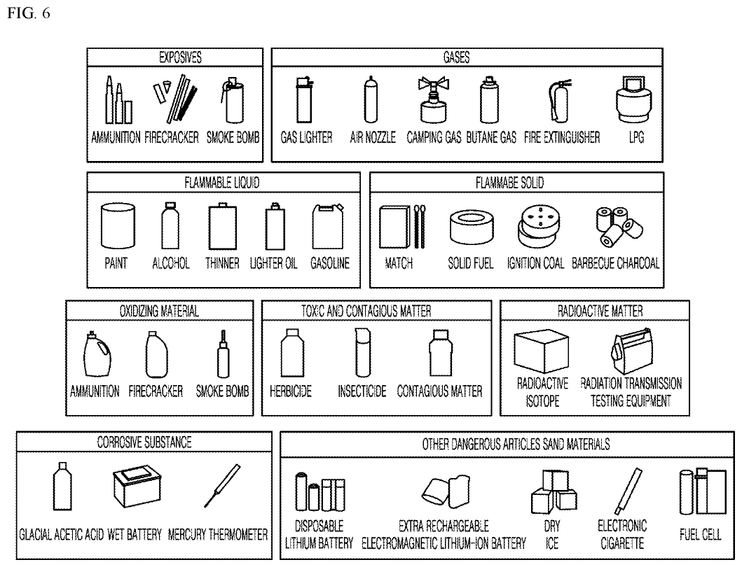

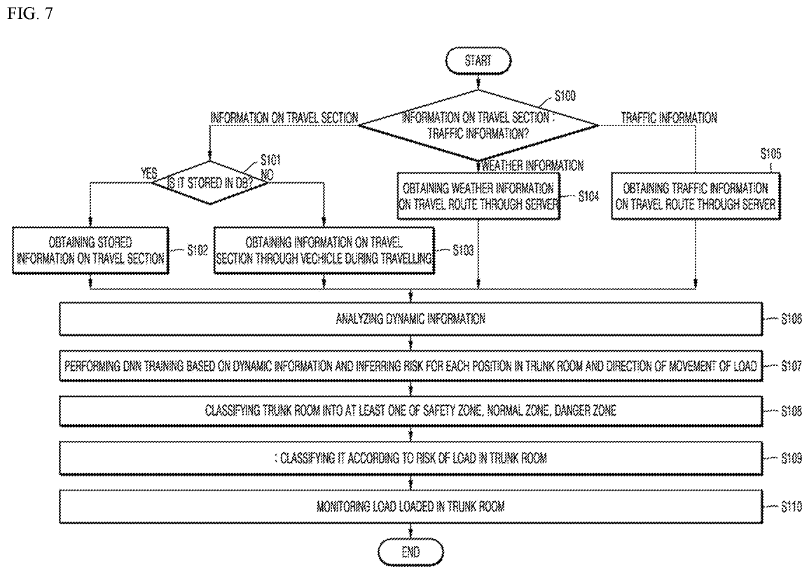

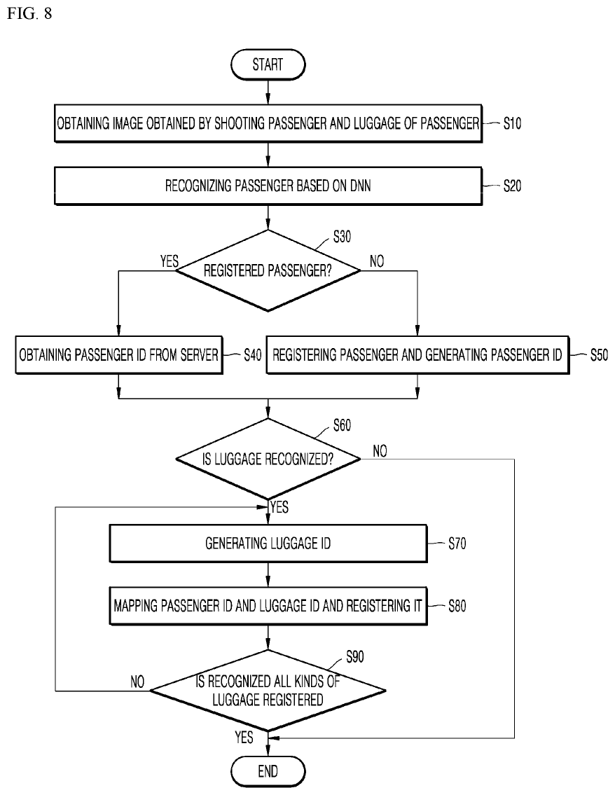

FIG. 4 shows an example of a safety zone and a normal zone in the trunk room determined by the DNN training processor in FIG. 2.

As shown in FIG. 4, a safety zone 251 may be placed in a normal zone 252, and may be placed at an upper portion of the normal zone 252 at a predetermined height.

The zone classifying unit 260 may place various kinds of loads in spaces of the trunk room, respectively, including based on the safety zone 251 and the normal zone 252 classified by the DNN training processor 250 according to a risk, a weight and a size of the load. That is, the zone classifying unit 260 compares the safety zone 251 and the normal zone 252 inferred based on a rank of the risk, a weight, and a size of new load with previously learned information and places various kinds of loads, in a finally classified space in the trunk room, respectively.

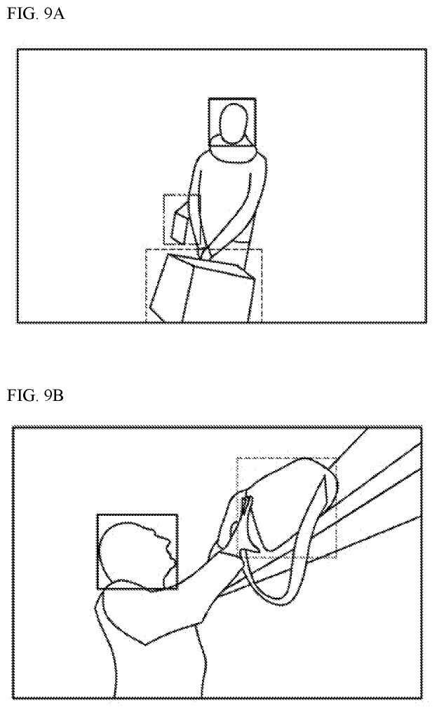

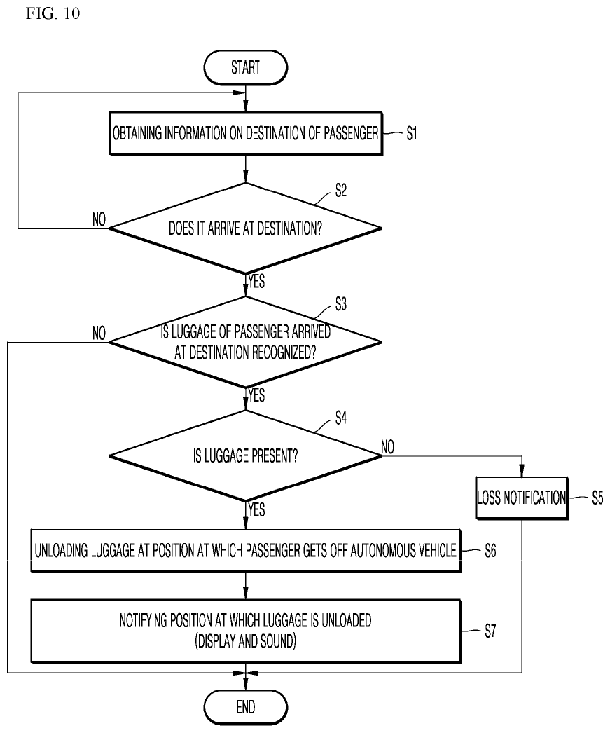

FIG. 5 shows an example space in a trunk room classified by the zone classifying unit in FIG. 2.

As shown in FIG. 5, a zone classifying unit 260 may allow load having high degree of risk to be loaded in a safety zone.

In some example, a grade of risk or a risk level of the loaded luggage may be classified according to items corresponding to contents of the luggage. In some implementations, the items corresponding to contents of the luggage may be determined through an X-ray system in a trunk room of a vehicle. Next, the grade of the risk may be determined based on colors of traffic light (a red color 261, a yellow color 262, and a green color 263) according to frequencies in which luggage include some materials in items of cases of Table 1 in the following.

For example, the red traffic light 261 may have a risk in which frequencies of cases are 70% or more, the yellow traffic light 262 may have a risk in which frequencies of cases are less than 70% and 30% or more, and the green traffic light 263 may have a risk in which frequencies of cases are less than 30%.

TABLE 1

| Case No. | Items of Cases |
|---|---|
| Case 1 | A case in which explosives are included in contents of the |
| | luggage. |
| Case 2 | A case in which gases are included in contents of the luggage. |
| Case 3 | A case in which flammable liquid is included in contents of |
| | the luggage. |
| Case 4 | A case in which flammable solid is included in contents of the |
| | luggage. |
| Case 5 | A case in which oxidizing material are included in contents of |
| | the luggage. |
| Case 6 | A case in which toxic materials and contagious matters are |
| | included in contents of the luggage. |
| Case 7 | A case in which radioactive substances are included in |
| | contents of the luggage. |
| Case 8 | A case in which corrosive substances are included in contents |
| | of the luggage. |
| Case 9 | A case in which other dangerous articles and materials are |
| | included in contents of the luggage. |

FIG. 6 shows an example items of the cases in Table 1 classified with respect to a risk of the luggage.

The monitoring processor 270 may provide an image on a display installed in an autonomous vehicle 200 so that a passenger may monitor his or her luggage when the luggage is loaded at a specific position when the passenger gets on an autonomous vehicle. In some implementations, the present disclosure is not limited to matters provided to the display, and the image may be provided to a user terminal 300 of the passenger for the passenger to monitor the luggage. Further, the image provided to the display or user terminal 300 may be provided with a view, using AR.

The monitoring processor 270 may display the position at which the luggage is unloaded when the passenger gets off the autonomous vehicle on a display installed outside of the autonomous vehicle 200 or notify the passenger of the position at which the luggage is unloaded through voice. Further, when the passenger is arrived at a destination, it is possible to automatically unload the luggage of the passenger.

Operation of the system for providing the service to load and store the article of the passenger according to the present disclosure will be described in detail with reference to the accompanying drawings. Reference numerals same as FIGS. 1 to 3 refer to same elements that perform the same functions.

FIG. 7 is a flowchart of an example method for providing a service to load and store an article of a passenger.

Referring to FIG. 7, a travel section collector 210 collects information on a travel section such as a curve, a slope road, a slip section, and a state of a road surface in a moving route to a destination thereof.

In some implementations, when the information on the travel section corresponding to the moving route is previously stored in a DB in a server 100 (S101), the information on the travel route such as the curve, the slope road, the slip section, and the state of the road surface in the moving route corresponding to the information on the travel section stored in the DB is collected (S102).

In contrast, when the information on the travel section corresponding to the moving route is not stored, in advance, in the DB in the server 100 (S101), the information on the travel section such as the curve, the slope road, the slip section, and the state of the road surface detected by another vehicle or his or her own vehicle is collected (S102). In some implementations, an accurate section of the travel section may be determined, through navigation, based on the collected information on the travel section (S103).

Further, a weather information collector 220 collects weather information, with respect to the moving route to the destination of the autonomous vehicle (S100).

In some implementations, the current weather information on the zone whether the autonomous vehicle 200 is currently placed, the weather information for period of time until which the autonomous vehicle 200 arrives at the destination thereof, the weather information for each zone (for each position) in the moving route of the autonomous vehicle 200 from the component or the server 100 of providing information on weather information (the Meteorological Administration) (S104).

Further, the traffic information collector 230 collects traffic information such as a road situation and a traffic situation (S100).

In some implementations, the traffic information for each zone (for each position) in the moving route of the autonomous vehicle 200 may be collected from the server 100 or a server of providing traffic information (Road Traffic Authority) (S105).

Then, the event section analyzer 240 analyzes the collected information on the travel section, weather information, and traffic information and analyzes dynamic information including a curved section, a slip section, and a slope section provided during travelling from a current position to an arrival place of the autonomous vehicle 200, a predicted speed for each section during travelling from a current position to an arrival place of the autonomous vehicle 200, and a dangerous situation occurring during travelling from a current position to an arrival place of the autonomous vehicle 200 (S106).

In more detail, in the event section analyzer 240, a road surface unevenness analyzer 241 analyzes unevenness of the road surface for each section of the travel route from the current position to the arrival place of the autonomous vehicle 200. In some implementations, the unevenness of the road surface may be analyzed based on the information on the section of the road surface having the unevenness of the road surface, collected by the travel section collector 210, but is not limited thereto. That is, when the information on the state of the road surface detected by another vehicle or his or her own vehicle during traveling is collected, it is possible to analyze the unevenness of the road surface based on the collected information on the state of the road surface.

Further, in the event section analyzer 240, a road surface smoothness analyzer 242 analyzes the smoothness of the road surface for each section of the travel route from the current position to the arrival place of the autonomous vehicle 200. In some implementations, the smoothness of the road surface may be analyzed based on the information on the section of the road surface having the smoothness of the road surface collected by the travel section collector 210, but is not limited thereto. That is, when the information on the road surface detected by another vehicle or his or her own vehicle during travelling is collected, it is possible to analyze the smoothness of the road surface based on the collected information on the road surface.

Further, in the event section analyzer 240, a curve analyzer 243 analyzes a route of a curve in a travel route from the current position to an arrival place of the autonomous vehicle 200. In some implementations, the route of the curve may be analyzed using the travel route collected by the travel section collector 210, but is not limited thereto. That is, when information on the curve detected by another vehicle or his or her own vehicle during travelling is collected, it is possible to analyze the section of the curve based on the information on the curve collected as described above.

Further, in the event section analyzer 240, a traffic analyzer 244 analyzes traffic for each section based on the traffic information including a road situation and a traffic situation occurring in the travel route from the current position to the arrival place of the autonomous vehicle 200. In some implementations, the traffic for each section may be analyzed based on the traffic information collected by the traffic information collector 230, but is not limited thereto. That is, when the traffic information detected by another vehicle or his or her own vehicle during traveling is collected, it is possible to analyze the traffic for each section based on the traffic information collected as described above.

Further, in the event section analyzer 240, the slope analyzer 245 analyzes the slope in the travel route from the current position to the arrival place of the autonomous vehicle 200. In some implementations, the slope section may be analyzed using the travel route collected by the travel section collector 210, but is not limited thereto. That is, when the information on the slope detected by another vehicle or his or her own vehicle during traveling is collected, it is possible to analyze the section of the slope based on the collected information on the slope.

Further, in the event section analyzer 240, a risk analyzer 246 analyzes a risk in the travel route from the current position to the arrival place of the autonomous vehicle 200. In some implementations, the risk analysis may be performed by analyzing the risk section such as a slide, a bump provided in the travel route, and a landslide and frequent accidents occurring in the travel route collected by the travel section collector 210, but is not limited thereto. That is, when the information on the risk detected by another vehicle or his or her own vehicle during travelling is collected, it is possible to analyze the risk section based on the collected information on the risk.

Next, a DNN training processor 250 performs training based on Deep Neutral Networks (DNN) using the dynamic information analyzed by the event section analyzer 240 and infer a risk for each position of the load loaded in a trunk room during traveling of the autonomous vehicle 200 or a direction of movement of the load during travelling of the autonomous vehicle 200 along the travel route (S107). In some implementations, the DNN training processor 250 may use learning data indicating stability according to the position of the trunk room, in addition to the analyzed dynamic information.

Then, the DNN training processor 250 classifies the trunk room into at least one of a safety zone, a normal zone, and a danger zone according to the inferred risk for each position of the load and direction of movement of the load during travelling along the travel route (S108). In some implementations, the classified zones are not limited thereto. For ease of explanation, the trunk room is divided into the safety zone and the normal zone.

In some implementations, the safety zone may be placed in the normal zone, and may be placed at an upper portion of the normal zone at a predetermined height.

Then, the zone classifying unit 260 may place various kinds of loads, in the spaces of the trunk room, respectively, including the safety zone and the normal zone classified by the DNN training processor 250 according to the risk, the weight, and the size of the load (S109). That is, the zone classifying unit 260 compares the previously learned information with the safety zone and the normal zone inferred based on the risk grade, the weight, and the size of new load and places various kinds of loads in the finally classified spaces in the trunk room, respectively.

In some examples, when the load is loaded at a specific position of the trunk room when the passenger gets on the autonomous vehicle, the monitoring processor 270 may provide a view on the display installed in the autonomous vehicle 200 using AR so that the passenger may monitor his or her own luggage (S110). To this end, the monitoring processor 270 recognizes the passenger and the luggage of the passenger when the passenger gets on the autonomous vehicle and may register the passenger and the luggage of the passenger when the passenger.

FIG. 8 is a flowchart of an example method of monitoring luggage performed by a monitoring processor.

Referring to FIG. 8, when a passenger boards an autonomous vehicle 200 and stores luggage, a monitoring processor 270 acquires an image obtained by capturing the passenger and the luggage of the passenger through a high-resolution camera installed in the autonomous vehicle 200 (S10).

Subsequently, the monitoring processor 270 recognizes the passenger based on the acquired image (S20). In some implementations, recognition of the passenger is performed through object detection of a face of the passenger, based on Deep Neural Networks (DNN).

When the passenger is recognized (S20), whether the recognized passenger is the registered passenger is identified by checking a previously stored passenger list of the autonomous vehicle (S30). The passenger may have a reservation in advance through the server 100 to use the autonomous vehicle 200. The information on the passenger who had a reservation (a passenger ID) is previously stored in the server 100. The monitoring processor 270 may identify whether the recognized passenger is the passenger who made a reservation in advance to use the autonomous vehicle 200 based on the information on the passenger stored in the server 100. However, this is an implementation and is not limited thereto. The information on the passenger may be previously stored through a method of registering many passengers, thereby determining whether the passenger is registered.

Thus, as a result of determination, when the passenger is the previously registered passenger, the identified information on the passenger may be obtained through the server 100 (S40).

Further, as a result of determination, when the passenger is not the previously registered passenger, it is possible to additionally generate information on the passenger (the passenger ID) to register the passenger (S50).

Subsequently, the monitoring processor 270 recognizes the luggage of the passenger based on the acquired image (S60). In some implementations, the recognition of the luggage of the passenger is performed through the object detection of luggage based on Deep Neural Networks (DNN).

When the luggage is recognized (S60), the ID of the recognized luggage (hereinafter referred to as “a luggage ID”) is generated (S70).

Subsequently, the monitoring processor 270 maps the generated luggage ID to the passenger ID of the passenger who is an owner of the luggage and registers the same (S80). Then, the monitoring processor 270 continues to map the luggage ID and the passenger ID until all kinds of recognized loads are registered (S90).

When the luggage is loaded at a specific location in the trunk room based on the mapping information registered, the monitoring processor 270 may provide the view on the display installed in the autonomous vehicle 200 or the user terminal 300 using the AR, so that the passenger may monitor his or her luggage.

In some implementations, FIGS. 9A and 9B show examples images obtained by capturing passengers and luggage of passengers by the monitoring processor in FIG. 8. That is, as shown in FIGS. 9A and 9B, the face of the passenger or the luggage held or carried by the passenger are recognized from the image which is obtained by capturing the passenger who boards the autonomous vehicle.

Further, the monitoring processor 270 may display a position at which the loaded luggage is unloaded when the passenger gets off the autonomous vehicle on the display installed outside of the autonomous vehicle 200 or guide the position at which the loaded luggage is unloaded through voice. Further, when the passenger is arrived at the destination thereof, it is possible to automatically load the luggage of the passenger.

FIG. 10 is a flowchart of an example monitoring method performed by a monitoring processor to notify unloading of loaded luggage of a passenger when the passenger gets off an autonomous vehicle.

Referring to FIG. 10, the monitoring processor 270 acquires information on destination of the passenger who boards an autonomous vehicle 200 (S1). In some implementations, the information on the destination of the passenger may be obtained, from the server 100, based on information on reservation of the passenger or information on the passenger, with respect to the autonomous vehicle 200. However, the present disclosure is not limited thereto, and the information on the destination of the passenger may be obtained through a ticket purchased by the passenger who boards the autonomous vehicle 200.

When the autonomous vehicle 200 moves from the current position of the autonomous vehicle 200 and arrives at the destination of the passenger (S2), the monitoring processor 270 identifies whether the luggage of the passenger is registered based on the passenger ID and the luggage ID which are mapped to each other (S3). Whether the luggage of the passenger is registered may be determined by checking whether the luggage ID is mapped to the passenger ID.

As a result of determination (S3), when the registered luggage ID is checked, the luggage having the ID checked in the trunk room is searched (S4). It may be searched using the recognized luggage of the passenger through the object detection of the luggage based on the Deep Neural Networks (DNN).

As a result of searching (S4), when the luggage of the passenger is not present in the trunk room, a loss notification is output (S5). In some implementations, the loss notification may be output to the user terminal 300, the display installed inside and outside of the autonomous vehicle 200, or through voice guidance.

Further, as a result of searching (S4), when the luggage of the passenger is present in the trunk room, it is possible to unload the luggage of the passenger when the passenger arrives at the destination (S6). In some implementations, when the position at which the passenger gets off the autonomous vehicle is different from the position at which the load is unloaded, the position at which the load is unloaded may be displayed on the display installed inside and outside of the autonomous vehicle 200 or the position at which the load is unloaded may be notified of the passenger through voice (S7).

As described above, while the present disclosure has been described with reference to exemplary drawings thereof, it is to be understood that the present disclosure is not limited to the implementations and drawings described in some implementations, and various changes can be made by the skilled person in the art within the scope of the technical idea of the present disclosure. Further, in the description of implementations of the present disclosure hereinabove, even though working effects based on configurations of the present disclosure are not explicitly described, effects which may be predicted based on the configuration can also be recognized.

What is claimed is:

1. A system for providing a service to load and store an article of a passenger of an autonomous vehicle, the system comprising:
an information collector configured to collect at least one of travel information of the autonomous vehicle, weather information, or traffic information, the travel information including information on a travel route from a current position to a destination of the autonomous vehicle;
an event section analyzer configured to analyze at least one of the travel information, the weather information, or the traffic information with dynamic information, the dynamic information comprising at least one of (i) information on a plurality of sections of the travel route including a curved section, a sliding section, or a slope section, (ii) a predicted speed of the autonomous vehicle corresponding to each section of the travel route, or (iii) an occurrence of a dangerous situation in the travel route;
a training processor configured to:
based on Deep Neural Networks (DNN) training using the dynamic information analyzed by the event section analyzer, determine a risk of damage corresponding to storage positions in a storage space of the autonomous vehicle that accounts for movement of loads in the storage space during travelling along the travel route, and
classify the storage space into at least one of a safety zone, a normal zone, or a danger zone according to the determined risk; and
a zone classifying unit configured to determine positions of a plurality of loads to be loaded among at least one of the safety zone, the normal zone, or the danger zone based on the determined risk of each load, a weight of each load, and a size of each load.

2. The system of claim 1, further comprising:
a monitoring processor configured to provide an image of luggage of the passenger to a user terminal of the passenger or to a display installed at the autonomous vehicle.

3. The system of claim 2, wherein the monitoring processor is configured to:
display, on the user terminal or the display, a position of the luggage at which the luggage is unloaded based on the passenger getting off the autonomous vehicle, or
notify the passenger of the position through a voice.

4. The system of claim 1, wherein the information collector is configured to:
collect the travel information, the travel information comprising at least one of the curve section, the slope section, the sliding section, or a state of a road surface in the travel route to the destination of the autonomous vehicle;
collect the weather information; and
collect the traffic information, the traffic information comprising at least one of a road situation or a traffic situation in the travel route.

5. The system of claim 4, wherein the weather information comprises (i) weather information on a place where the autonomous vehicle is located, (ii) weather information for a period of time while the autonomous vehicle travels to the destination of the autonomous vehicle, and (iii) weather information corresponding to each section of the travel route of the autonomous vehicle.

6. The system of claim 1, wherein the event section analyzer is configured to:
analyze an unevenness and a smoothness of a road surface corresponding to each section of the travel route, wherein the unevenness represents a topography of each section of the travel route, and the smoothness represents a slipperiness of each section of the travel route;
analyze a curve and a slope in the travel route;
analyze traffic corresponding to each section of the travel route based on the traffic information, the traffic information comprising at least one of a road situation or a traffic situation predicted to occur while the autonomous vehicle travels along the travel route; and
determine a risk section comprising at least one of a slippery region, a bump region, a landslide region, or a frequent accident region in the travel route.

7. The system of claim 1, wherein the safety zone is positioned in the normal zone or at a predetermined height vertically above the normal zone.

8. A method for providing a service to load and store an article of a passenger of an autonomous vehicle, the method comprising:
collecting at least one of travel information on a travel route of the autonomous vehicle to a destination, weather information, or traffic information;
analyzing at least one of the travel information, the weather information, or the traffic information with dynamic information, the dynamic information comprising at least one of (i) information on a plurality of sections of the travel route including a curved section, a sliding section, or a slope section, (ii) a predicted speed of the autonomous vehicle corresponding to each section of the travel route, or (iii) an occurrence of a dangerous situation in the travel route;
determining, based on Deep Neural Networks (DNN) training using the dynamic information, a risk of damage corresponding to storage positions in a storage space of the autonomous vehicle that accounts for movement of loads in the storage space during travelling along the travel route;
classifying the storage space into at least one of a safety zone, a normal zone, or a danger zone according to the determined risk; and
determining positions of a plurality of loads to be loaded among at least one of the safety zone, the normal zone, or the danger zone based on the determined risk of each load, a weight of each load, and a size of each load.

9. The method of claim 8, wherein collecting at least one of the travel information, the weather information, and the traffic information comprises:
collecting information on the plurality of sections and a state of a road surface in the travel route;
collecting at least one of (i) weather information on a place where the autonomous vehicle is located, (ii) weather information for a period of time while the autonomous vehicle travels to the destination of the autonomous vehicle, and (iii) weather information corresponding to each section of the travel route of the autonomous vehicle; and
collecting the traffic information, the traffic information comprising at least one of a road situation or a traffic situation in the travel route.

10. The method of claim 9, wherein collecting the travel information comprises:
based on the travel information being previously stored in a database, obtaining information stored in the database corresponding to the travel route; and
based on travel information not being previously stored in the database, obtaining information on the travel route that is detected by another vehicle or the autonomous vehicle travelling the travel route.

11. The method of claim 8, wherein analyzing the dynamic information comprises:
analyzing an unevenness an a smoothness in a road surface of each section in the travel route, wherein the unevenness represents a topography of each section of the travel route, and the smoothness represents a slipperiness of each section of the travel route;
analyzing a curve and a slope in the travel route;
analyzing a traffic for each section of the travel route based on the traffic information, the traffic information comprising at least one of a road situation or a traffic situation in the travel route; and
determining a risk section comprising at least one of a slippery region, a bump region, a landslide region, or a frequent accident region in the travel route.

12. The method of claim 8, further comprising:
providing an image of luggage of the passenger to a user terminal of the passenger or to a display installed in the autonomous vehicle.

13. The method of claim 12, wherein providing the image of the luggage comprises:
based on the passenger getting on the autonomous vehicle, acquiring a first image of at least one of the passenger and the luggage of the passenger by a camera installed at the autonomous vehicle;
recognizing the passenger or the luggage of the passenger based on the first image;
based on recognizing the passenger, determining whether the recognized passenger corresponds to a registered passenger previously stored in a passenger list;
based on the recognized passenger corresponding to an unregistered passenger in the passenger list, generating information comprising an identification of the unregistered passenger, and registering the unregistered passenger in the passenger list as a registered passenger;
based on the recognized passenger corresponding to the registered passenger previously stored in the passenger list, acquiring information corresponding to the registered passenger through a server, the information corresponding to the registered passenger comprising an identification of the registered passenger;
based on recognizing the luggage, generating a luggage identification (ID) corresponding to the recognized luggage;
generating mapping information based on mapping the luggage ID to the identification of the corresponding passenger; and
based on the mapping information, providing, to the display or the user terminal, the image of the luggage that is loaded at a position in the storage space.

14. The method of claim 13, wherein recognizing the passenger or the luggage of the passenger is performed through an object detection of a face of the passenger and a shape of the luggage using the DNN.

15. The method of claim 12, further comprising:
based on the passenger getting off the autonomous vehicle, displaying, on the user terminal or the display, a position at which the luggage is unloaded; or
notifying the passenger of the position through a voice.

16. The method of claim 15, wherein displaying the position of the luggage or notifying the passenger of the position of the luggage comprises:
obtaining information on a first destination of a first passenger in the autonomous vehicle;
based on the autonomous vehicle arriving at the first destination, determining whether first luggage of the first passenger is registered in mapping information comprising a passenger ID and a luggage ID that are mapped to each other;
based on a determination that the first luggage is registered in the mapping information, identifying the first luggage in the storage space based on the luggage ID corresponding to the first luggage;
based on identifying the first luggage present in the storage space, unloading the first luggage at the first destination.

17. The method of claim 16, wherein displaying the position of the luggage or notifying the passenger of the position of the luggage further comprises:
outputting a loss notification based on determining an absence of the first luggage in the storage space.

18. The method of claim 16, further comprising:
based on an unload position at which the first luggage is unloaded being different from a position of the first passenger at which the first passenger gets off the autonomous vehicle, displaying the unload position to a first display installed inside of the autonomous vehicle and a second display installed outside of the autonomous vehicle.

19. The method of claim 16, further comprising:
based on a unload position at which the first luggage is unloaded being different from a position of the first passenger at which the first passenger gets off the autonomous vehicle, displaying the unload position to a user terminal of the first passenger.

20. The method of claim 16, further comprising:
based on an unload position at which the first luggage is unloaded being different from a position of the first passenger at which the first passenger gets off the autonomous vehicle, providing the first passenger with a guide to the unload position.
